(19) United States
(12) Patent Application Publication
(10) Pub. No.: US 2022/0351283 A1
(43) Pub. Date: Nov. 3, 2022

(54) SYSTEM AND METHOD TO FACILITATE SAVING MONEY FOR A COMMON GOAL

(71) Applicant: Maurice Lewis, JR., College Park, MD (US)

(72) Inventor: Maurice Lewis, JR., College Park, MD (US)

(21) Appl. No.: 17/656,881

(22) Filed: Mar. 29, 2022

Related U.S. Application Data
(60) Provisional application No. 63/183,065, filed on May 3, 2021.

(51) Int. Cl. G06Q 40/02

(52) U.S. Cl. CPC G06Q 40/02

(57) ABSTRACT

Disclosed is a system and method for saving money for a common goal amongst a plurality of users. The disclosed system and method allow a group of users to create a financial goal, contribute funds together for the financial goal by pooling money in one place and distribute the pooled sum of money amongst the group users in a customized manner of withdrawal defined by the group. This allows the flexibility of choosing the mode of withdrawal based on requirements and needs of the group.

### TECHNICAL FIELD

Various embodiments are directed to systems and methods for financial planning, money management and electronic payments. More particularly, the present disclosure relates to money management using electronic means and computer processor enabled platform for the same.

### BACKGROUND

While most people recognize the importance of saving money, many people find it very difficult to do so. Additionally, when it comes to a family or a group of friends or acquaintances or colleagues, there arises scenario where all of them have to save towards a common goal such as, for example, buying a gift for someone. This provides additional complexity because each person may have their own financial commitments.

Currently there exists multiple money management platforms which provide a solution for financial planning and money management. However, these systems provide a solution at an individual level. In addition, most of these systems only provide systems for planning and tracking of money and don't facilitate monetary transactions as such. For that an individual has to use other platforms that facilitate monetary transactions.

Furthermore, these solutions don't provide a single platform for multiple users to manage their money for a common goal. In addition to the above, these systems don't ensure that the combined pool of money is not used before the common goal is reached. Moreover, using the existing systems, the users would have to use multiple platforms, multiple applications to do the same.

Moreover, the existing solutions charge a hefty transaction fee from users for transactions and have a cumbersome process of onboarding users and setting up of goals requiring extensive documentation. Creating a group investment pool of money is quite a hectic process and constrained by banking and payment terminal regulations.

In the light of the above-mentioned shortcomings associated with existing money management systems, it is highly desirable to have a system which could facilitate financial planning and monetary management for a group of people.

### SUMMARY

Embodiments of the present disclosure present technological improvements as solutions to one or more of the above-mentioned technical problems recognized by the inventor in conventional solutions.

The present invention discloses a system and method for saving money for a common goal by a group of people and allow the withdrawal or usage of money contingent upon reaching/achieving the common goal. Disclosed below is a system and method for facilitating saving money for a common goal The present invention relates to a system and method for facilitating pooling of money by multiple users towards a common savings goal wherein the system and method allows users to create a group of users, set a common goal and pool in money together for that common goal. Additionally, the present disclosure allows the withdrawal of money only upon reaching/achieving the common goal using different methods of distribution that the users can choose from. After setting up deadline and goal, users are given multiple options for distribution of funds once goal is reached based on a set of predefined rules.

In the primary embodiment of the present invention, it discloses a system and method comprising a hardware processor communicably coupled via a communication network with one or more user devices and a memory device wherein the processor 102 enables a user to create a group of plurality of users, wherein the plurality of users are aiming to save money for a common goal.

In additional aspects of the present invention, the system and method provides a single platform for saving towards a common goal, unlike existing solutions where people have to use multiple apps for money transfer. Further, the system and methods disclosed herein has multiple levels of security integrated, which enables access to one or more features of the present invention to the users based on their level of security clearance. This ensures that the pooled funds are not misused by any users.

An alternative embodiment of the present invention provides a system and method with integrated Artificial Intelligence and Machine Learning module which facilitates, including but not limited to tracking and analysis of user patterns thereby enabling fraud detection, and other metrics and provide detailed report of the same.

Additional aspects, advantages, features and objects of the present disclosure would be made apparent from the drawings and the detailed description of the illustrative embodiments construed in conjunction with the complete specification that will follow.

It will be appreciated that features of the present disclosure are susceptible to being combined in various combinations without departing from the scope of the present disclosure.

While the systems and methods are illustrated by use of cell phone embodiments and applications, they are equally applicable to virtually any portable or mobile communication device, including for example, wireless laptop computers and PDAs.

### BRIEF DESCRIPTION OF DRAWINGS

The summary above, as well as the following description of illustrative embodiments are better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 a schematic illustration of the system for facilitating saving money for a common goal, in accordance with an embodiment of the present disclosure;

FIG. 2 depicts a distribution process as per the present disclosure;

FIG. 3 depicts another distribution process as per the present disclosure.

FIG. 4 depicts other distribution process as per the present disclosure.

FIG. 5 depicts a flowchart for the method steps as per the present disclosure

### DESCRIPTION OF EMBODIMENTS

The following description illustrates embodiments of the present disclosure and ways in which they can be implemented. Although some modes of carrying out the present disclosure have been disclosed, those skilled in the art would recognize that other embodiments for carrying out or practicing the present disclosure are also possible.

The present invention discloses a system and method for saving money for a common goal amongst a plurality of users. The disclosed system and method allow a group of users to create a financial goal, contribute funds together for the financial goal by pooling money in one place and distribute the pooled sum of money amongst the group users in a customized manner of withdrawal defined by the group. This allows the flexibility of choosing the mode of withdrawal based on requirements and needs of the group, rather than being constrained by regulatory procedure adopted by existing financial institutions and conventional fintech applications.

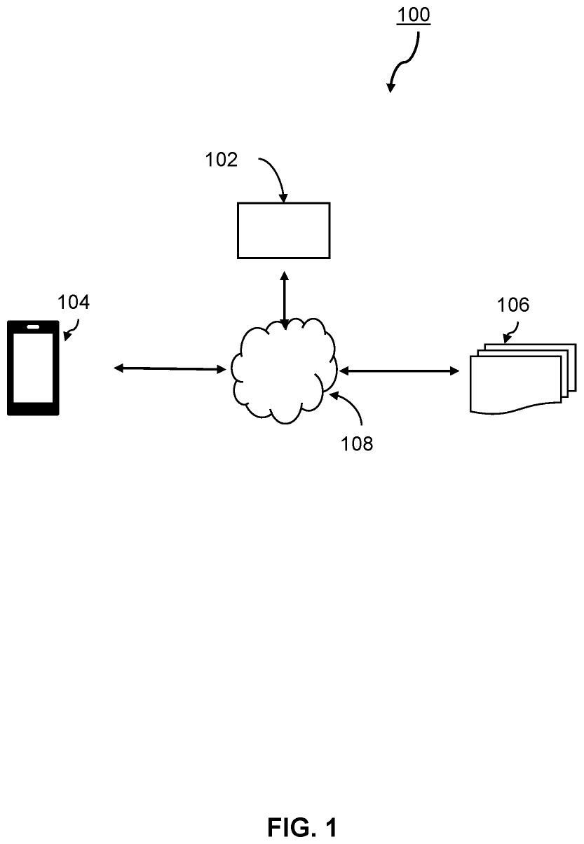

FIG. 1 is a schematic illustration of an exemplary embodiment of the system 100, wherein the system comprises a processor 102 communicably coupled via a communication network 108 with a first user device 104, and a memory 106. The processor 102 is configured to facilitate saving of money for a common goal wherein the system and method allows users to create a group of users, set a common goal and pool money together for said common goal.

The first user device is operable to communicate to the hardware processor by means of the communication network. The first user device is provided with a native application with a user interface. The native application allows a user to register on the system by entering user details wherein the user details include name, address, bank account and other KYC information. Optionally, a user may directly register without the KYC details. Once the user is registered, the user is assigned a unique identifier. The native application is connected to a payment gateway that allows a user to make monetary transactions by linking his bank account.

The user is able to create, through the user interface, a common goal for saving. Throughout this disclosure, the common goal is referred to as “pot”. The user creating the pot is referred to as “admin” in this disclosure. The pot is created by the user to meet a financial need at a later point of time and distribute the pot amongst one or more users. In order to create a pot, the admin is required to input pot details such as pot size, pot timeline and pot members.

In an aspect of the present invention, the processor 102 receives pot details from an admin. The pot details include information pertaining to pot name, pot amount, pot tenure, start date, member count, goal criteria, distribution method etc. Once the pot details are received, the processor 102 is configured to create the pot based on pot details received from the admin.

Once the pot is created, the processor 102 is configured to accept member details from the admin. The admin can add one or more members to the pot. In a preferred embodiment of the present invention, the processor 102 receives details from the admin with respect to a type of member. A member can be of two types: a contributor member or a beneficiary member. Throughout this disclosure, a contributor member is a user who adds money to the pot. Further, a beneficiary member is one who receives money from the pot. Optionally, a user can be a contributor member and a beneficiary member simultaneously. In case, a member is not designated as contributor or beneficiary explicitly, then the member shall be treated as both contributor and beneficiary.

In an embodiment of the present invention, the amount of contribution from each contributor member can be equal or customized for each member. Similarly, the distribution of pot amount to beneficiary members can be equal or customized for each beneficiary member. The system is flexible to incorporate various combinations of members in terms of contribution and beneficiary and it shall be appreciated that all such combinations are within the scope of this disclosure.

The admin can add as many members as required. In an embodiment, the user creating the pot can designate members as contributor or beneficiary. The processor 102 is configured to send a notification to a user who is added as contributor member or a beneficiary member and receiving user details from said users. The processor 102 is further operable to receive details pertaining to contribution amount and contribution frequency for the contribution member. The contribution frequency can be set to a lumpsum one time payment or a recurring payment set to a weekly, monthly or yearly payment based on pot details. In some embodiments of the present invention, the contributor members are required to contribute equal amounts to the pot on regular intervals until the desired pot amount is achieved. In other embodiments, the contributor members may be allowed to contribute money based on their comfort and convenience. In some other embodiments of the same invention, the system is enabled to automatically transfer amounts to the pot from the contributor member's accounts.

In another aspect, the processor 102 receives details with respect to a distribution method for the pot amount based on admin selection. The term distribution method refers to a how the pooled money from the pot shall be distributed amongst the members. The disclosed invention allows several distribution methods for distributing pot amount. In preferred embodiment of the present invention, the admin is provided with one or more pre-fixed distribution methods. As an example, without limiting the scope of present invention, one of the pre-fixed distribution method is where all members receive pot amounts equally. Optionally, another distribution methods is where only one of the members receive the entire pot amount. Optionally, only members designated as beneficiary members are distributed the pot amount. In another embodiment, the processor 102 is operable to enable the admin to create a customized distribution method for the pot amount amongst pot members.

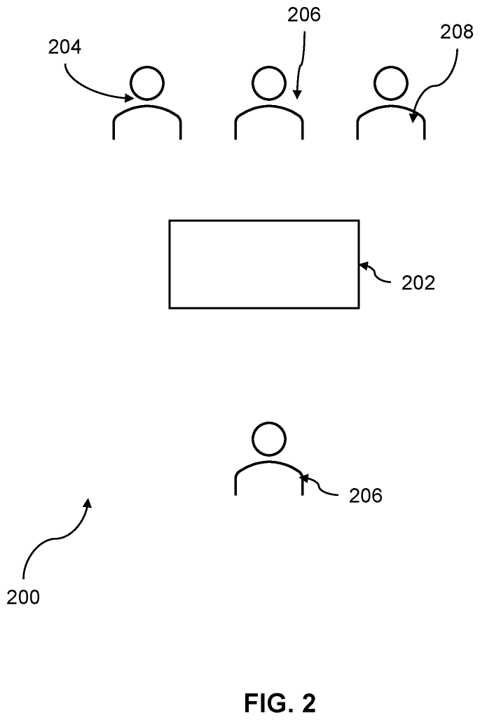

FIG. 2 depicts a distribution process 200 as per the present disclosure. 204, 206 and 208 are contributors to the pot 202 and 206 is the beneficiary to whom pot amount is transferred.

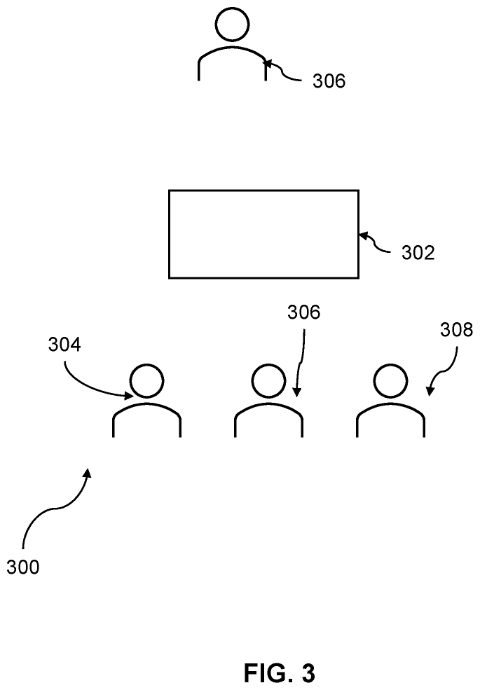

FIG. 3 depicts another distribution process 300 as per the present disclosure. 304 is the contributor to the pot 302 and 306, 308, 310 and 312 are the beneficiary to whom pot amount is transferred.

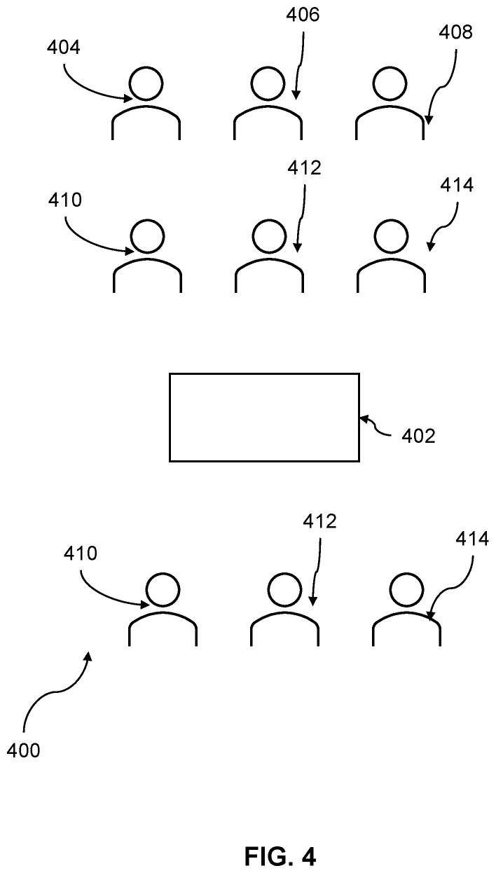

FIG. 4 depicts other distribution process 400 as per the present disclosure. 404, 406,408, 410, and 412 and 414 are the contributors to the pot 402 and 410, 412 and 414 are the beneficiary to whom the pot amount is to be transferred.

In yet another aspect, the processor 102 is configured to receive, from the admin, a goal completion target. A goal completion target could be a time-based. As an example, on 30^{th} of every month. Optionally, the goal completion target could be event based. Example of said event-based goal completion could be completion of a course or any other event of contingent nature. In case of an event-based goal, the processor 102 is configured to receive, from one or more members, goal completion evidence. Non-limiting examples of said goal completion evidence are completion certificate or attendance certificate. The goal completion evidence can be uploaded through the user interface of the native application. Optionally, the pot creator can decide the time to disburse the pot amount. In such cases, the processor 102 receives disbursement instructions from the pot creator through the user interface. At the time of pot creation, the processor 102 sets a flag in the memory and once the goal completion target is achieved, the flag is reset by the processor 102. The processor 102 is configured to disburse the pot amount once the flag is reset.

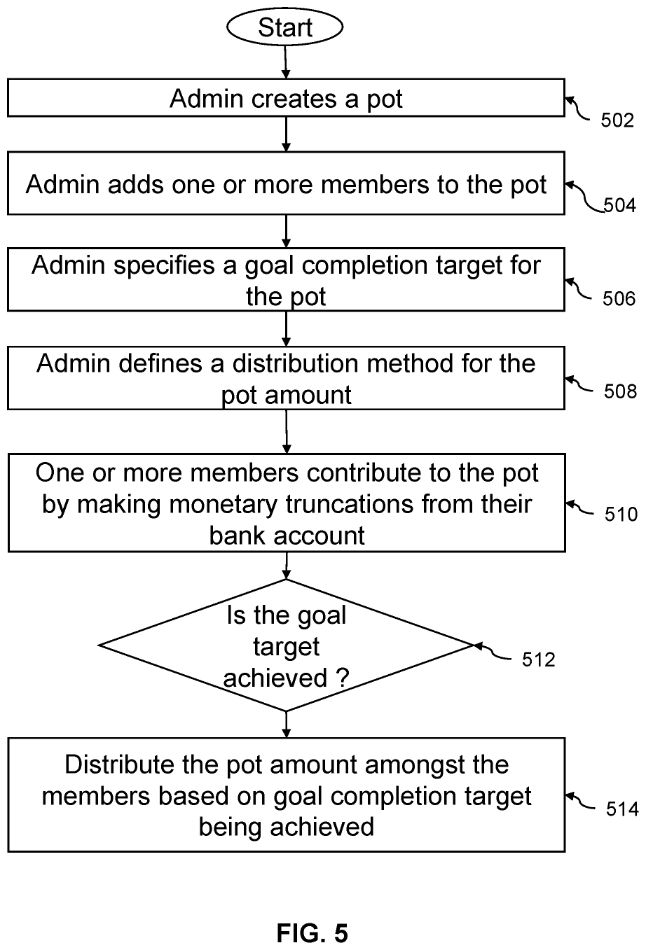

FIG. 5 depicts a flowchart for the method steps 500 as per the present disclosure. At step 502, an admin creates a pot. The pot is created by entering pot details such as pot name, pot tenure, pot amount, start date etc. At step 504, the admin adds one or more members to the pot. Further, at step 506, the admin specifies a goal completion target for the pot. At step 508, the admin defines a distribution method for the pot amount. At step 510, the one or more members contribute to the pot by making monetary truncations from their bank account. At step 512, processor identifies if the goal completion target is achieved. At step 514, distributes the pot amount amongst the members based on goal completion target being achieved.

As an example, without limiting the scope of the invention, a group of friends are planning to gift a friend something for his birthday. The person planning the whole thing can create a group of users who would be participating. Further, the user can fix a budget limit. The friends can then contribute money by transferring money to a central account created for this purpose by the system. Once the budget target is reached, then the person planning can withdraw the amount or route it to the concerned parties for buying the gift.

Further, in another embodiment, the system and methods disclosed herein has multiple levels of security integrated. This ensures that un-authorised people wouldn't be able to withdraw the money. This also prevents fraudulent transactions.

In an alternate embodiment of the invention, the system enables the saving of money for a goal only for a single user as well, without creating a group. In this case, the user is only enabled to withdraw the money contingent upon satisfaction of the goal/criteria set by the user.

An alternative embodiment of the present invention provides a system and method with integrated Artificial Intelligence and Machine Learning module which facilitates, including but not limited to tracking and analysis of user patterns thereby enabling fraud detection, and other metrics and provide detailed report of the same. Further, this facilitates the system to generate a book of accounts for each group.

In an alternative embodiment of the same invention, the said invention is built using a distributed ledger-based platform such as blockchain. The system and method facilitate pooling of cryptocurrency in this embodiment. Additionally, smart contracts can be added wherein the smart contracts would facilitate automatic disbursement of funds as decided by the users upon achieving the common savings goal. Having a blockchain based platform ensures that the transactions can be tracked and no one can mis-use the present system.

Additional or less units can be included without deviating from the novel art of this disclosure. In addition, each unit can include any number and combination of sub-units, and systems, implemented with any combination of hardware and/or software units.

Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor 102 receives (reads) instructions and data from a memory (such as a read-only memory and/or a random-access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk.

Throughout this disclosure the term “user device” refers to devices such as, but not limited to, a mobile phone, tablet, a laptop, a personal computer connected to a widely accessible network such as the Internet, a portable computing device connected to a widely accessible network such as the Internet, any graphical user interface enabling a user to enter an input, a portable communication device, or a personal digital assistant connected to the one or more data communication network. In the following description, the term “user device” refers to any of the communication devices mentioned above or an equivalent.

Various embodiments of the present invention may also be implemented in verticals other than pooling money. For illustration purposes only, without limiting the scope of the invention, users may be enabled to contribute materials other than money. For example, the users may be having a target of pooling resources for a specific goal.

Beneficially, some of the embodiments of the present technical solution may also be modified to provide benefits including but not limited to (a) providing a single platform for combined savings goal for multiple users; (b) single platform for saving money and facilitating transactions instead of having multiple applications/platforms (c) Various channels/ways of disbursement of the saved money as defined by the users (d) Promotes the users to save the money and attain the common goal because unless it is achieved, the money pooled cant be withdrawn/disbursed.

Any examples or illustrations given herein are not to be regarded in any way as restrictions on, limits to, or express definitions of, any term or terms with which they are utilized. Instead, these examples or illustrations are to be regarded as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion.

Modifications to embodiments of the present disclosure described in the foregoing are possible without departing from the scope of the present disclosure as defined by the accompanying claims. Although an exemplary embodiment of at least one of a system and a method has been illustrated in the accompanied drawings and described in the foregoing detailed description, it will be understood that the application is not limited to the embodiments disclosed, but is capable of numerous rearrangements, modifications, and substitutions as set forth and defined by the following claims.

The description, embodiments and figures are not to be taken as limiting the scope of the claims. It should also be understood that throughout this disclosure, unless logically required to be otherwise, where a process or method is shown or described, the steps of the method may be performed in any order, repetitively, iteratively or simultaneously. At least portions of the functionalities or processes described herein can be implemented in suitable computer-executable instructions. It will be appreciated that features of the present disclosure are susceptible to being combined in various combinations and additional features may be introduced without departing from the scope of the present disclosure.

1. A system for facilitating money saving towards a common goal, comprising a processor communicably coupled via a communication network with one or more user devices and a memory, wherein the processor is configured to:
receive, through a native application installed on a user device, from an admin information pertaining to:
one or more pot details;
a goal completion target for the pot; and
one or members to be added to the pot;
create a pot based on the information received from the admin;
define a distribution method based on admin selection;
distribute the pot amongst the members subsequent to goal completion target being achieved.

2. The system of claim 1 wherein the pot details comprise pot name, pot amount, member count, and start date of the pot.

3. The system of claim 1 wherein the goal completion target is one of time based or event based.

4. The system of claim 1 wherein the one or more members of the pot are classified into either contributor member or a beneficiary member.

5. The system of claim 1 wherein the distribution method is selected from one or more pre-fixed distribution models.

6. The system of claim 1 wherein the distribution model is customized by the admin.

7. A method for facilitating money saving towards a common goal, comprising a processor communicably coupled via a communication network with one or more user devices and a memory, wherein the processor is configured for:
receiving, through a native application installed on a user device, from an admin information pertaining to:
one or more pot details;
a goal completion target for the pot; and
one or members to be added to the pot;
creating a pot based on the information received from the admin;
defining a distribution method based on admin selection;
distributing the pot amongst the members subsequent to goal completion target being achieved.

8. The method of claim 7 wherein the pot details comprise pot name, pot amount, member count, and start date of the pot.

9. The method of claim 7 wherein the goal completion target is one of time based or event based.

10. The method of claim 7 wherein the one or more members of the pot are classified into either contributor member or a beneficiary member.

11. The method of claim 7 wherein the distribution method is selected from one or more pre-fixed distribution models.

12. The method of claim 7 wherein the distribution model is customized by the admin.
